(19) United States
(12) Patent Application Publication
(10) Pub. No.: US 2021/0271513 A1
(43) Pub. Date: Sep. 2, 2021

(54) GENERIC PEER-TO-PEER PLATFORM AS A SERVICE FRAMEWORK

(71) Applicant: SAP SE, Walldorf (DE)

(72) Inventors: Mayank Tiwary, Rourkela (IN); Pritish Mishra, Bangalore (IN); Shashank Mohan Jain, Karnataka (IN)

(21) Appl. No.: 16/804,849

(22) Filed: Feb. 28, 2020

(51) Int. Cl. G06F 9/48; G06F 9/54; H04L 29/08

(52) U.S. Cl. CPC G06F 9/4856; G06F 9/547; H04L 61/1511; H04L 67/02; H04L 67/104

(57) ABSTRACT

Some embodiments may be associated with a peer-to-peer platform as a service framework. A control plane processor may push a workload associated with a client request to a peer-to-peer platform as a service in accordance with resource availability. A data plane may include a plurality of node processors, and a first node processor may receive a job from the control plane and determine if: (i) the first node processor will execute the job, (ii) the first node processor will queue the job for later execution, or (iii) the first node processor will route the job to another node processor. In some embodiments, the first node processor may provide sandboxing for tenant specific execution (e.g., implemented via web assembly).

### BACKGROUND

Centralization of Platform as a Service (“PaaS”) for batch and one-time jobs may lead to a loss of autonomy (e.g., if reliance and trust is placed on public cloud providers) and to wasting resources that have already been provisioned (e.g., by an enterprise to employees in the form of laptops, desktops and smartphones). Today, these resources are not put to full utilization in terms of running workloads and applications (e.g., executing unit tests, running build systems for Continuous Integration (“CI”) and/or Continuous Deployment (“CD”) needs, scans for antiviruses, tasks such as image processing or distributed deep learning, etc.). Currently, these types of tasks get executed on developer machines (unit tests) or a cloud computing environment (either public or private) which can lead to increased resource costs and operations. In addition to cost benefits, executing tasks (e.g., unit tests) in parallel across nodes in a peer-to-peer fashion may enhance developer productivity by providing faster execution of these tasks.

In some cases, these tasks may be addressed in isolation via peer-to-peer systems, but there is a need for a generic framework that provides computation derived from peer-to-peer systems and that can orchestrate workloads across peer-to-peer nodes. It would therefore be desirable to provide a peer-to-peer PaaS framework in a secure, automatic, and accurate manner.

### SUMMARY

Methods and systems may be associated with a peer-to-peer platform as a service framework. A control plane processor may push a workload associated with a client request to a peer-to-peer platform as a service in accordance with resource availability. A data plane may include a plurality of node processors, and a first node processor may receive a job from the control plane and determine if: (i) the first node processor will execute the job, (ii) the first node processor will queue the job for later execution, or (iii) the first node processor will route the job to another node processor. In some embodiments, the first node processor may provide sandboxing for tenant specific execution (e.g., implemented via web assembly).

Some embodiments comprise: means for pushing, by a control plane processor, a workload associated with a client request to a peer-to-peer platform as a service in accordance with resource availability; means for receiving, at a first node processor of a data plane including a plurality of node processors, a job from the control plane; means for deciding, by the first node processor, if the first node processor will execute the job; means for deciding, by the first node processor, if the first node processor will queue the job for later execution; and means for deciding, by the first node processor, if the first node processor will route the job to another node processor.

Some technical advantages of some embodiments disclosed herein are improved systems and methods to provide a peer-to-peer PaaS framework in a secure, automatic, and accurate manner.

### BRIEF DESCRIPTION OF THE DRAWINGS

FIG. 1 is a high-level block diagram of a peer-to-peer computing system.

FIG. 2 is a high-level system architecture in accordance with some embodiments.

FIG. 3 is a method according to some embodiments.

FIG. 4 is a WASM runtime framework on executor nodes in accordance with some embodiments.

FIG. 5 is a high-level block diagram of web assembly system in accordance with some embodiments.

FIG. 6 shows a distributed database process on a database node according to some embodiments.

FIG. 7 shows a peer-to-peer platform as a service orchestration process on an orchestration node in accordance with some embodiments.

FIG. 8 is a method for executing a use test case to peer-to-peer node processors according to some embodiments.

FIG. 9 is a method for delegating a build system to peer-to-peer node processors in accordance with some embodiments.

FIG. 10 is a method for offloading an anti-virus scan to peer-to-peer node processors according to some embodiments.

FIG. 11 is a method for offloading an image processing task to peer-to-peer node processors in accordance with some embodiments.

FIG. 12 is a human machine interface display according to some embodiments.

FIG. 13 is an apparatus or platform according to some embodiments.

FIG. 14 illustrates a web assembly database in accordance with some embodiments.

FIG. 15 illustrates a tablet computer according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

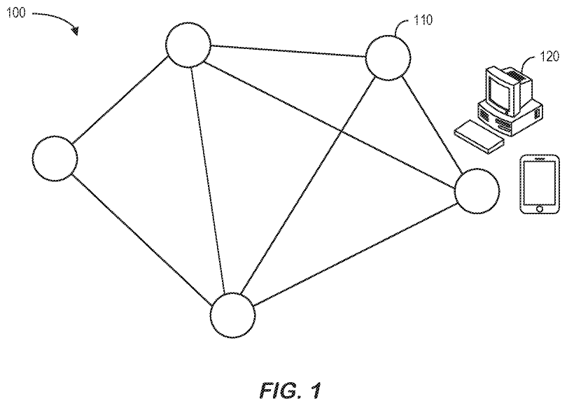

As used herein, the phrase “peer-to-peer” may refer to any distributed application architecture that partitions tasks or workloads between peers. For example, FIG. 1 illustrates a peer-to-peer network 100 with multiple node processors 110 (e.g., each being associated with a smartphone 120, laptop computer, tablet computer, desktop computer, etc.). Note that the node processors may be are equally privileged, equipotent participants in the network 100. They are said to form a peer-to-peer network of nodes. The node processors 110 may make a portion of their resources (e.g., processing power, disk storage, and/or network bandwidth) directly available to other network participants, without the need for central coordination by servers or stable hosts. Note that node processors 110 may be both suppliers and consumers of resources (in contrast to the traditional client-server model in which divides the consumption and supply of resources).

Some embodiments described herein run a peer-to-peer PaaS framework for one-time and batch jobs that provides facilities for the placement and/or parallelization of workloads on peer-to-peer nodes based on resource availability. Moreover, some embodiments may provide an ability to discover which nodes are participating in a peer-to-peer cluster and/or the appropriate security primitives (both from workload not impacting the node and node not impacting the workload). In addition, basic persistence needs for workloads may be provided via the availability of a peer-to-peer filesystem such as an Inter-Planetary File System (“IPFS”).

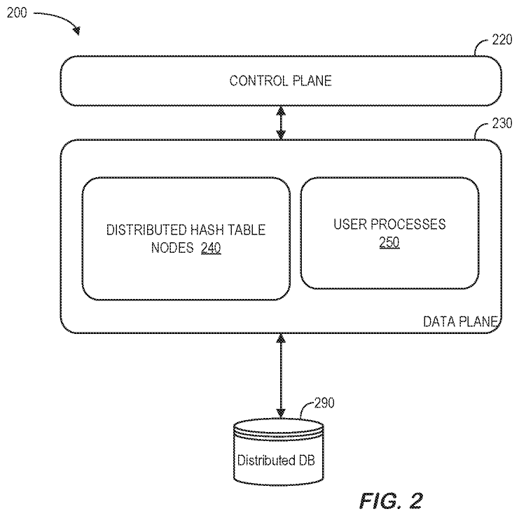

To provide a generic peer-to-peer PaaS framework in a secure, automatic, and accurate manner, FIG. 2 is a high-level system 200 architecture in accordance with some embodiments. The system 200 includes a control plane 220 and a data plane 230. As used herein, devices, including those associated with the system 200 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The control plane 220 may be responsible for providing capabilities like publishing tasks to the peer-to-peer PaaS over a Representational State Transfer (“REST”) Application Programming Interface (“API”). The control plane 220, which may include an orchestrator, can expose a REST API to consumers to publish/push the workload to the peer-to-peer PaaS. In some embodiments, an orchestrator acts as a gateway to provide Hyper-Text Transfer Protocol (“HTTP”) on top of a Distributed Hash Table (“DHT”). By way of example, to push a workload a client might make a request such as:
curl -X PUT http://<<ip>>:<<port>>/jobs/jobid -d<<job blob>>
   The orchestrator node may drain the blob and apply any authentication and/or authorization of the client before submitting the job for execution. Internally, the orchestrator might divide the job if appropriate (e.g., for unit tests or distributed compilation) and then use DHT to submit jobs to specific nodes.

The orchestrator might then query the state of the jobs (either on demand via a request issued by the client or via a scheduled job running on the orchestrator). Clients may interface to the PaaS via the orchestrator, which could be run on a cloud or any other machine on premises that provides a stable endpoint for clients to consume. The orchestrator itself could be made Highly Available (“HA”) by using techniques such as a floating IP address or Domain Name System (“DNS”) based mechanisms.

The data planes 230 may include DHT nodes 240 and user processes 250 and may exchange information with a distributed database 290. The DHT nodes 240 might either route a request made by a control plane 220 orchestrator to nearby keys (or, if they themselves are responsible, execute the request or queue the request when the node is busy). The DHT nodes 240 may participate in computation and provide sandboxing for a tenant-specific workload. The sandbox allows safe execution of a workload and prevents noisy neighbor scenarios by providing resource quota enforcement in terms of memory, Central Processing Unit (“CPU”) usage, Input Output (“IO”), etc.

A Trusted Execution Environment (“TEE”) environment may provide guarantees to a workload provider that a malicious peer-to-peer node cannot peek into what the workload is doing and whether there is any tempering of the workload being done. The TEE might be, for example, an Intel® based Software Guard Extensions (“SGX”) or similar approaches, such as the Keystone for Reduced Instruction Set Computer (“RISC”) V5. Note that the DHT nodes 240 may use local storage for scratch space or can rely on IPFS based nodes to persist files with long durability.

The data plane 230 may store information into and/or retrieve information from various data stores, such as the distributed database 290, which may be locally stored or reside remote from the data plane 230. Although a single data plane 230 is shown in FIG. 2, any number of such devices may be included. Moreover, various devices described herein might be combined according to embodiments of the present invention. For example, in some embodiments, the data plane 230 and distributed database 290 might comprise a single apparatus. The system 200 functions may be performed by a constellation of networked apparatuses, such as in a distributed processing or cloud-based architecture.

An administrator may access the system 200 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to implement various rules and policies) and/or provide or receive automatically generated recommendations or results from the system 200.

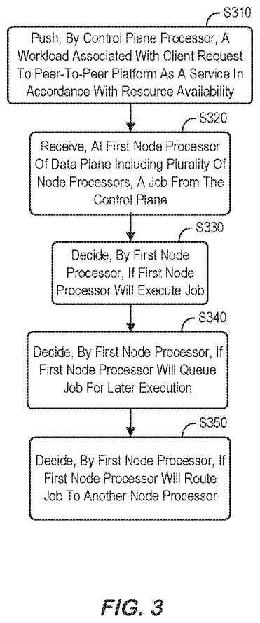

FIG. 3 is a method that might performed by some or all of the elements of any embodiment described herein. The flow charts described herein do not imply a fixed order to the steps, and embodiments of the present invention may be practiced in any order that is practicable. Note that any of the methods described herein may be performed by hardware, software, an automated script of commands, or any combination of these approaches. For example, a computer-readable storage medium may store thereon instructions that when executed by a machine result in performance according to any of the embodiments described herein.

At S310, a control plane processor may push a workload associated with a client request to a peer-to-peer platform as a service in accordance with resource availability. At S320, a first node processor of a data plane (including a plurality of node processors) may receive a job from the control plane (e.g., the workload might have been split into a number of smaller jobs). At S330, the first node processor may decide if the first node processor will execute the job. At S340, the first node processor may instead decide if the first node processor will queue the job for later execution (e.g., when the first node processor is currently performing another task). At S350, the first node processor may instead decide that the first node processor will route the job to another node processor in the network.

In this way, a framework is provided to use computing nodes in a peer-to-peer setup (which might include any type of computing node such as a laptop, a desktop system, a smartphone, etc.) to leverage computation resources for PaaS offerings. Some embodiments may use of function execution as Web Assembly (“WASM”) instructions (e.g., to avoid cold-start problems) and the WASM runtime may execute functions in a sandboxed environment. A WASM runtime may also offer computing resource isolation while executing functions in a serverless fashion and allow for effective resource utilization. Note that a PaaS offering might be associated with several different types of basic computational elements/roles, such as:
Execution Nodes,
Database Nodes, an
Orchestration Nodes.

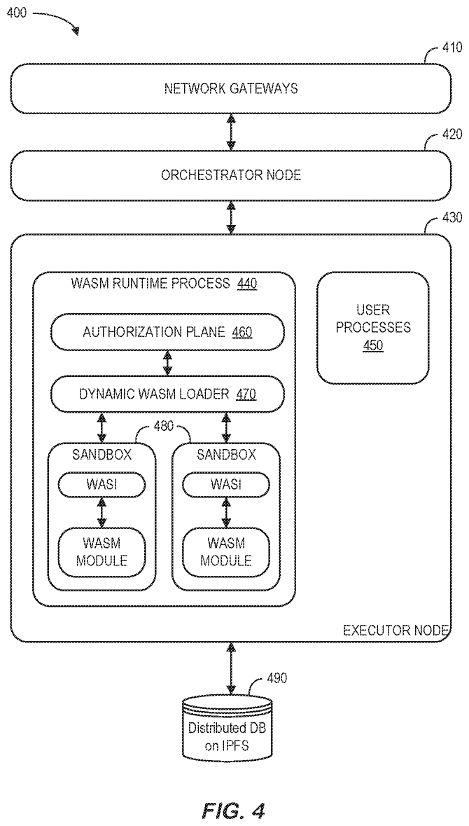

FIG. 4 is a system 400 associated with a WASM runtime framework on an executor node 430 in accordance with some embodiments. Network gateways 410 may execute the executor node 420 via an orchestrator node 420. The executor node 430 may include user processes 450 and a WASM runtime process 440 (including an authorization plane 460, dynamic WASM loader 470, and multiple sandboxes 480 (e.g., each having a Web Assembly System Interface (“WASI”) and WASM module). The executor node 430 may access information in a distributed database on IPFS 490.

Any node available in an organization may be assigned a role (e.g., execution, database or orchestration) after which the node starts offering service. In some embodiments, election methods may elects execution nodes, database nodes, and orchestration nodes based on availability. When a node gets a assigned an executor role, the WASM runtime process 440 starts running with normal user processes 450.

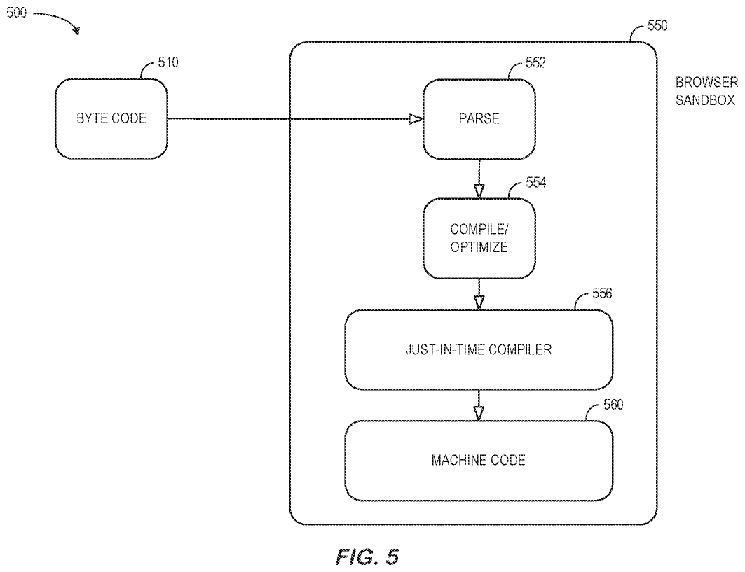

Note that WASM is a binary format of compilation target for high level languages and a low-level bytecode for the web. It is designed as an abstraction for underlying hardware architecture and runs in an isolated sandboxed environment, allowing platform independence for programmers. Most of the high-level language such as C, C++, RUST, etc. can also be converted to web-assembly with an intention to offer near-native speed execution by leveraging common hardware capabilities. FIG. 5 is a high-level block diagram of a WASM system 500 in accordance with some embodiments. In particular, a browser sandbox 550 may execute byte code 510 (e.g., Java, Advanced Business Application Programming (“ABAP”), etc). The browser sandbox 550 may utilize a parse element 552 and a compile/optimize element 254 on the byte code 510 before executing a Just-In-Tim (“JIT”) compiler 556. The output of the JIT compiler 556 may comprise machine code 560.

Note that the WASM runtime process 440 offers a sandboxed execution environment by creating a continuous memory heap for each sandbox 480. To allow system calls for instructions that execute inside a sandbox 480 (preventing access from inside the WASM sandbox 480 to outside memory). Further, with a threaded model (where each thread executes a WASM function) CPU isolation is also achieved by setting a timer on the thread and then executing a handler to remove the WASM module after that time expires. The proposed runtime achieves filesystem isolation by separating disks and mounting disks for each runtime process. Further, on the principles of capability-based security the runtime assigns File Descriptors (FDs) to WASM functions in a controlled manner. In order to abstain access from outside the WASM sandbox to inside memory, embodiments may rely on security enclaves such as Intel's SGX architecture. Any process running in user-space can easily get compromised using a root access. So, it's possible that the WASM runtime process can get compromised which can allow data leaks from the WASM heaps or sandboxes. However, in some embodiments a runtime may use Intel's SGX SDK instruction set to create enclaves. Later, the WASM heaps are protected by using SGX instructions and executing the WASM in the enclaves where security is ensured by hardware.

Traditionally, WASM is executed within a browser process. Note, however, that it can also be executed on standalone or outside browsers if the runtimes are accompanied with interfaces to facilitate system calls. In some embodiments, the WASM runtimes execute as a separate process which runs a given WASM function using a thread. The WASM runtime process can be provisioned easily with a Virtual Machine (“VM”) or container (or can even run on a bare machine or host Operating System (“OS”) directly). The runtime has dynamic WASM loading capabilities which can load new WASM functions directly to memory without restarting the runtime process.

Other Security features of a WASM runtime may include separation of execution stack from heap (avoiding buffer overflow kind of attacks) and a lack of direct references to function pointers to control the instruction pointer and thereby ensure Control Flow Integrity (“CFI”). Moreover, embodiments may not provide access to system calls by default (exposing only needed file descriptors to the specific WASM module). Inspired by capability-based security models made famous by Open BSD capsicum and Micro kernels (e.g., Google Fuchsia) can reduce the attack surface considerably.

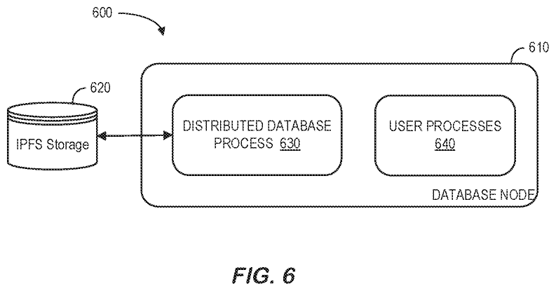

FIG. 6 shows 600 a distributed database process 630 and user processes 640 on a database node 610 according to some embodiments. Each node with a database role runs the distributed database process 630 where for the persistence the database process 630 uses IPFS storage 620 for persistence and writes to IPFS with a publish-subscribe pattern for data consistency and integrity. Any WASM function can use the APIs available from the distributed database process 630 for data persistence.

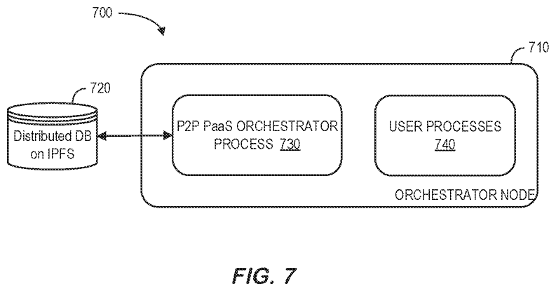

FIG. 7 shows 700 a peer-to-peer PaaS orchestration process 730 and user processes 740 on an orchestration node 710 in accordance with some embodiments. A user request initially arrives at a network gateway and then the gateway forwards the request to an orchestrator node 710. The orchestrator process 730 running on orchestration node 710 stores the mapping of functions to API in the distributed database on IPFS 720 as key-value pairs. When the orchestrator process 730 receives a user request, it forwards the request to a respective execution node based on stored key-value pairs. The orchestration process 730 may also, in some embodiments, be responsible when a user does a first-time registration for serverless functions. The orchestration process 730 creates a new key-value pair in the database for key as API and value as the location of the respective WASM module. If an executor process is initialized, the orchestrator assigns the executor process with WASM modules and later forwards user requests to specific runtimes as per mapping. During initialization, the executor process (after receiving the list of WASM modules from an orchestrator) downloads the WASM from cloud storage such as Amazon's Simple Storage Service (“S3”).

The orchestrator node 710 is not only are responsible for forwarding the traffic as per key-value mappings but may also maintain the load information (current CPU, memory, and/or IO utilization) to distribute the function execution as per load statistics. For example, a customer can define the criteria/custom-policy for load distributions (using exposed attributes such as CPU, memory, and IO). In this case, the PaaS orchestration layer may also provide a default set of load distribution policies to be used by customers. Based on the current policy, the orchestrator may performs function placement to respective nodes as appropriate.

Assigning roles to a new node may be an important part of a PaaS offering (e.g., because of its impact to service availability). Each node has the freedom to come into peer-to-peer and offer computing resources. When a node freshly comes in a peer-to-peer network, a primary process running on the node may assign the role to the device/node. The primary process on the node may fetch the role-assignment table (which stores the mapping of roles to devices/nodes) from a central storage or a database such as a Relational Database Service (“RDS”). The process initially checks if there are at-least two orchestrator nodes, if not the process assigns orchestrator role to the device. Secondly, if there are already a sufficient number of orchestrator nodes in the peer-to-peer network, the primary process may check for database nodes. If there are no database nodes, the process assigns a database role to the node. Otherwise the process assigns the executor role to node/device. The nodes in the peer-to-peer network check the availability as per gossip protocol. The orchestrator nodes may only be responsible for updating the central role-assignment table (whereas the other nodes may participate in the peer-to-peer only by updating the orchestrator nodes about availability).

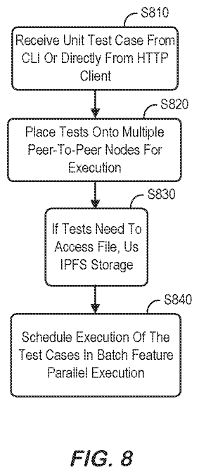

Note that embodiments may be applicable to many different types of tasks that could be executed via the peer-to-peer PaaS framework. For example, FIG. 8 is a method for executing a use test case to peer-to-peer node processors according to some embodiments. At S810, the orchestrator receives the unit test cases from the CLI or directly via HTTP client. The orchestrator node places the tests on to multiple peer-to-peer nodes for execution at S820. In the process of executing the unit test cases, if the tests needs to access any file (e.g., a Java-Script Object Notation (JSON”) parsing unit test) from filesystem, as per the peer-to-peer PaaS architecture, the peer-to-peer nodes use a IPFS storage filesystem at S830 which internally again uses a DHT to manage storage blocks. As a result, the offloader will store the dependent files on IPFS storage (and subsequently it will be accessed by the actual computing node). The orchestrator node may then eventually schedule the execution of test cases in batch featuring parallel execution at S840.

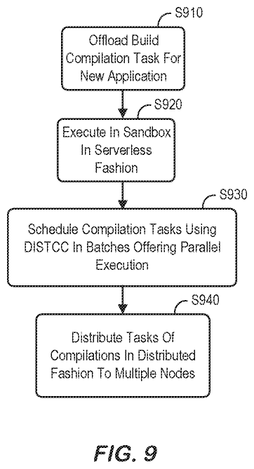

As another example, FIG. 9 is a method for delegating a build system to peer-to-peer node processors in accordance with some embodiments. Traditionally, when an application is initiated for execution on any PaaS, the first step the build pack performs is to compile the codebase and assembly/bytecode. In this process, the compilation task is offloaded to build systems running on containers, which compiles the code and outputs the desired. In this system, there is no guarantee of executing the compilation tasks in a multi-tenanted fashion. In the peer-to-peer PaaS, such build systems run on peer-to-peer nodes at S910, where the compilers/interpreters are executed within sandbox in a serverless fashion at S920 (executing the compilation tasks in a multi-tenanted fashion). The orchestrator node also schedules the compilation tasks at S930 (using distcc, which is a program designed to distribute compiling tasks across a network to participating hosts) in batches offering parallel execution. In some embodiments, the distcc distributes the tasks of compilations at 940, which allows for the compilation of a codebase in a distributed fashion across multiple peer-to-peer nodes.

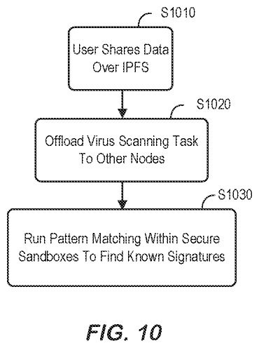

As still another example, FIG. 10 is a method for offloading an anti-virus scan to peer-to-peer node processors according to some embodiments. Note that most virus scanners simply scan the content of known extension files to perform a pattern matching operation over the content and a known signature set. This often becomes compute intensive, because the entire content of the file needs to be scanned. However, in peer-to-peer PaaS, if a user shares the data over IPFS at S1010 the virus scanning task may be offloaded to other peer-to-peer nodes at S1020. The other peer-to-peer nodes may then run pattern-matching within secure sandboxes at S1030 (e.g., one function may run a Knuth-Morris-Pratt (“KMP”) string-searching algorithm while other sandboxes use bloom filters).

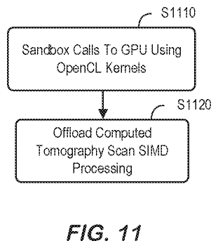

As yet another example, FIG. 11 is a method for offloading an image processing task to peer-to-peer node processors in accordance with some embodiments. Note that it is often desirable for peer-to-peer nodes to have access to a Graphics Processing Unit (“GPU”) abilities. In this case, a sandbox can easily make calls to a GPU using OpenCL kernels at S1110 and, thus, offload image processing or tasks which utilize Single Instruction, Multiple Data (“SIMD”) processing at S1120. For example, Computer Tomography (“CT”) scan processing might be offloaded to other peer-to-peer nodes.

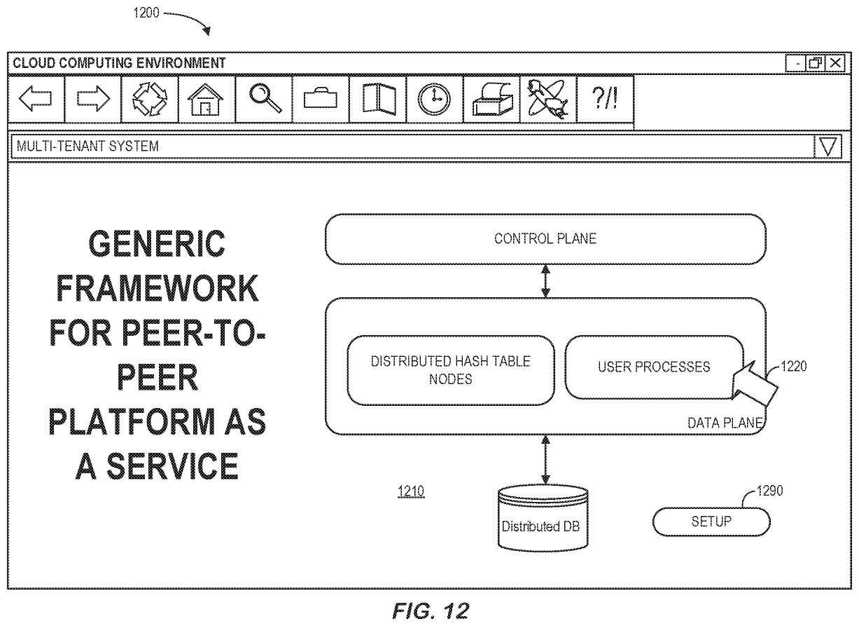

FIG. 12 is a human machine interface display 1200 in accordance with some embodiments. The display 1200 includes a graphical representation 1210 of elements of peer-to-peer platform as a service framework system for a cloud computing environment (e.g., to securely execute actors for multiple tenants). Selection of an element (e.g., via a touchscreen or computer pointer 1220) may result in display of a pop-up window containing various options (e.g., to adjust rules or logic, assign various devices, etc.). The display 1200 may also include a user-selectable “Setup” icon 1290 (e.g., to configure parameters for cloud management/provisioning (e.g., to alter or adjust processes as described with respect any of the embodiments of FIGS. 2 through 11)).

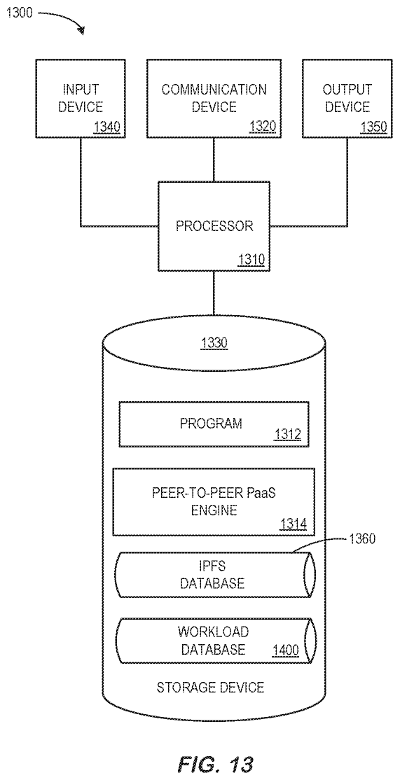

Note that the embodiments described herein may be implemented using any number of different hardware configurations. For example, FIG. 13 is a block diagram of an apparatus or platform 1300 that may be, for example, associated with the system 200 of FIG. 2 (and/or any other system described herein). The platform 1300 comprises a processor 1310, such as one or more commercially available Central Processing Units (“CPUs”) in the form of one-chip microprocessors, coupled to a communication device 1360 configured to communicate via a communication network (not shown in FIG. 13). The communication device 1360 may be used to communicate, for example, with one or more remote user platforms, cloud resource providers, etc. The platform 1300 further includes an input device 1340 (e.g., a computer mouse and/or keyboard to input rules or logic) and/an output device 1350 (e.g., a computer monitor to render a display, transmit recommendations, and/or create data center reports). According to some embodiments, a mobile device and/or PC may be used to exchange information with the platform 1300.

The processor 1310 also communicates with a storage device 1330. The storage device 1330 can be implemented as a single database or the different components of the storage device 1330 can be distributed using multiple databases (that is, different deployment information storage options are possible). The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or peer-to-peer PaaS engine 1314 for controlling the processor 1310. The processor 1310 performs instructions of the programs 1312, 1314, and thereby operates in accordance with any of the embodiments described herein. For example, the processor 1310 may push a workload associated with a client request to a peer-to-peer platform as a service in accordance with resource availability. A data plane may include a plurality of node processors, and the processor 1310 may receive a job from the control plane and determine if: (i) the processor 1310 will execute the job, (ii) the processor 1310 will queue the job for later execution, or (iii) the processor 1310 will route the job to another node processor. In some embodiments, the processor 1310 may provide sandboxing for tenant specific execution (e.g., implemented via web assembly).

The programs 1312, 1314 may be stored in a compressed, uncompiled and/or encrypted format. The programs 1312, 1314 may furthermore include other program elements, such as an operating system, clipboard application, a database management system, and/or device drivers used by the processor 1310 to interface with peripheral devices.

As used herein, information may be “received” by or “transmitted” to, for example: (i) the platform 1300 from another device; or (ii) a software application or module within the platform 1300 from another software application, module, or any other source.

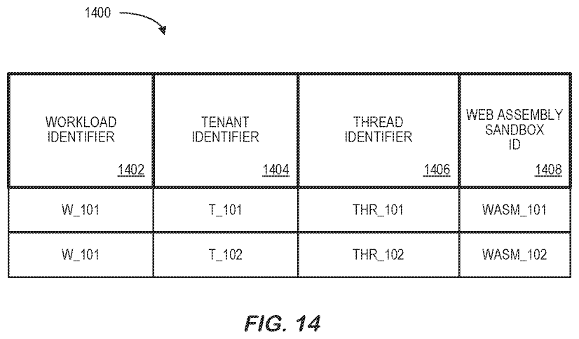

In some embodiments (such as the one shown in FIG. 13), the storage device 1330 further stores IPFS database 1360 and a workload database 1400. An example of a database that may be used in connection with the platform 1300 will now be described in detail with respect to FIG. 14. Note that the database described herein is only one example, and additional and/or different information may be stored therein. Moreover, various databases might be split or combined in accordance with any of the embodiments described herein.

Referring to FIG. 14, a table is shown that represents the workload database 1400 that may be stored at the platform 1400 according to some embodiments. The table may include, for example, entries mapping PaaS resources (e.g., employee smartphones) that may be utilized by applications. The table may also define fields 1402, 1404, 1406, 1408, for each of the entries. The fields 1402, 1404, 1406, 1408 may, according to some embodiments, specify: a workload identifier 1402, a tenant identifier 1404, a thread identifier 1406, and a web assembly sandbox identifier 1408. The workload database 1400 may be created and updated, for example, when a new workload is initiated, a resource is added, etc. According to some embodiments, the workload database 1400 may further store details about each tenant or thread (e.g., a multi-tenant policy).

The workload identifier 1402 might be a unique alphanumeric label or link that is associated with a particular workload being executed for multiple tenants. The tenant identifier 1404 might identify an organization or enterprise (e.g., and as shown in FIG. 14 multiple tenant identifiers are associated with a single workload “W_101”). The thread identifier 1406 might identify an available thread that was selected from a pool of threads, and the web assembly sandbox identifier 1408 might identify a particular sandbox where a function is being executed.

Thus, embodiments may provide a framework which encapsulates the right primitives for users to push mundane jobs like unit tests, builds, virus scanning, etc. to a decentralized environment. Moreover, existing nodes (e.g., within a corporate network) can be securely and reliably utilized to accomplish these tasks (instead of having dedicated resources provisioned from cloud which adds costs to perform these jobs).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

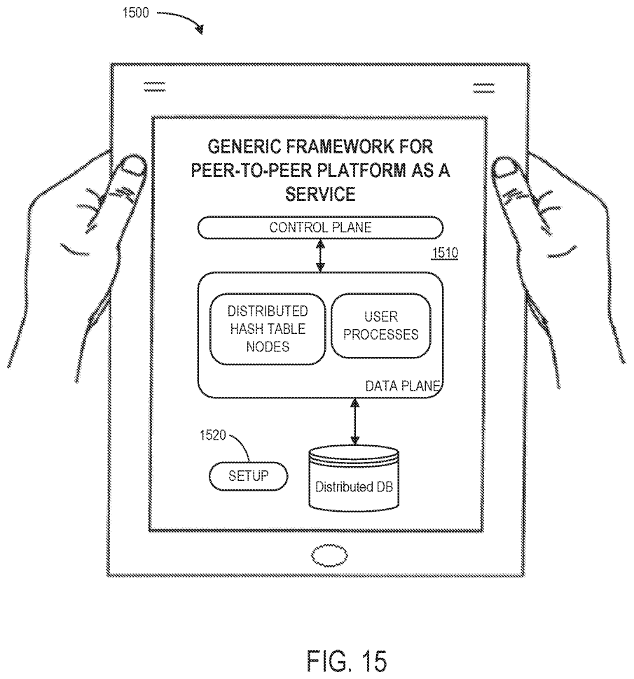

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of applications and services, any of the embodiments described herein could be applied to other types of applications and services. In addition, the displays shown herein are provided only as examples, and any other type of user interface could be implemented. For example, FIG. 15 shows a tablet computer 1500 rendering a generic framework for peer-to-peer PaaS display 1510. The display 1510 may, according to some embodiments, be used to view more detailed elements about components of the system (e.g., when a graphical element is selected via a touchscreen) or to configure operation of the system (e.g., to establish new rules or logic for the system via a “Setup” icon 1520).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system, comprising:
a control plane processor to push a workload associated with a client request to a peer-to-peer platform as a service in accordance with resource availability, and
a data plane including a plurality of node processors, wherein a first node processor receives a job from the control plane and determine if:
(i) the first node processor will execute the job,
(ii) the first node processor will queue the job for later execution, or
(iii) the first node processor will route the job to another node processor.

2. The system of claim 1, wherein the workload is associated with at least one of: (i) a one-time job, and (ii) a batch job.

3. The system of claim 1, wherein the control plane processor comprises an orchestrator that publishes the workload via an exposed Representational State Transfer (“REST”) Application Programming Interface (“API”).

4. The system of claim 3, wherein the orchestrator acts as a gateway to provide Hyper-Text Transfer Protocol (“HTTP”) on top of a Distributed Hash Table (“DHT”).

5. The system of claim 3, wherein the orchestrator is further to divide the workload into multiple jobs to be executed by multiple node processors in parallel.

6. The system of claim 3, wherein the orchestrator is further to authenticate a client that submitted the client request.

7. The system of claim 3, wherein the orchestrator is made highly available using at least one of: (i) floating Internet Protocol (“IP”) address, and (ii) a Domain Name System (“DNS”) mechanism.

8. The system of claim 1, wherein the first node processor provides sandboxing for tenant specific execution.

9. The system of claim 8, wherein the sandboxing is implemented via web assembly.

10. The system of claim 8, wherein the first node processor the sandboxing is associated with a Trusted Execution Environment (“TEE”).

11. The system of claim 1, wherein the workload is associated with executing a use test case to peer-to-peer node processors.

12. The system of claim 1, wherein the workload is associated with delegating a build system to peer-to-peer node processors.

13. The system of claim 1, wherein the workload is associated with offloading an anti-virus scan to peer-to-peer node processors.

14. The system of claim 1, wherein the workload is associated with offloading an image processing task to peer-to-peer node processors.

15. The system of claim 14, wherein the image processing task is associated with a Single Instruction, Multiple Data (“SIMD”) task.

16. A computer-implemented method, comprising:
pushing, by a control plane processor, a workload associated with a client request to a peer-to-peer platform as a service in accordance with resource availability;
receiving, at a first node processor of a data plane including a plurality of node processors, a job from the control plane;
deciding, by the first node processor, if the first node processor will execute the job;
deciding, by the first node processor, if the first node processor will queue the job for later execution; and
deciding, by the first node processor, if the first node processor will route the job to another node processor.

17. The method of claim 16, wherein the workload is associated with at least one of: (i) a one-time job, and (ii) a batch job.

18. The method of claim 16, wherein the control plane processor comprises an orchestrator that publishes the workload via an exposed Representational State Transfer (“REST”) Application Programming Interface (“API”).

19. A non-transitory, computer readable medium having executable instructions stored therein, the medium comprising:
instruction to push, by a control plane processor, a workload associated with a client request to a peer-to-peer platform as a service in accordance with resource availability;
instruction to receive, at a first node processor of a data plane including a plurality of node processors, a job from the control plane;
instruction to decide, by the first node processor, if the first node processor will execute the job;
instruction to decide, by the first node processor, if the first node processor will queue the job for later execution; and
instruction to decide, by the first node processor, if the first node processor will route the job to another node processor.

20. The medium of claim 19, wherein the first node processor provides sandboxing for tenant specific execution.

21. The medium of claim 20, wherein the sandboxing is implemented via web assembly.
